(19) United States
(12) Patent Application Publication
(10) Pub. No.: US 2007/0069511 A1
(43) Pub. Date: Mar. 29, 2007

(54) Gas generator

(75) Inventor: Masayuki Nakayasu, Tatsuno-Shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-Shi (JP)

(21) Appl. No.: 11/528,416

(22) Filed: Sep. 28, 2006

Related U.S. Application Data
(60) Provisional application No. 60/722,979, filed on Oct. 4, 2005.

(30) Foreign Application Priority Data
Sep. 29, 2005 (JP) 2005-284290

(51) Int. Cl. B60R 21/26

(52) U.S. Cl. 280/737; 280/742

(57) ABSTRACT

The present invention provides a gas generator including: a cylindrical housing having two opening portions; an ignition device chamber connected to one of the opening portions of the cylindrical housing; a diffuser portion connected to the other opening portion of the cylindrical housing and having a gas discharge port; a first blockage member closing between the cylindrical housing and the ignition device chamber; a second blockage member closing between the cylindrical housing and the diffuser portion; a pressurized gas charged inside the cylindrical housing, a rod, for rupturing the second blockage member to open a path to the diffuser portion in actuation, being provided inside the cylindrical housing, a base portion of the rod being disposed to face the first blockage member, a distal end portion of the rod being disposed to face the second blockage member, the rod including the distal end portion having a flat surface which faces the second blockage member and a central portion which is other than the distal end portion and the base portion, an outer diameter of the distal end portion being larger than that of the central portion.

This nonprovisional application claims priority under 35 U.S.C. §119(a) on Patent Application No. 2005-284290 filed in Japan on 29 Sep. 2005, and 35 U.S.C. §119(e) on U.S. Provisional Applications No. 60/722979 filed on 4 Oct. 2005, which are incorporated by reference.

### BACKGROUND OF THE INVENTION

1. Field of Invention

The present invention relates to a gas generator for use in a restraining device for a vehicle.

2. Description of Related Art

In a gas generator that inflates an air bag in a vehicle occupant restraining device or a pedestrian protection device, an air bag is connected to a gas discharge port. Therefore, it is preferable that an igniter, which is connected to a lead wire for ignition, is not provided in the vicinity of the gas discharge port, because the lead wire is an obstacle when connecting an air bag to the gas discharge port.

U.S. Pat. No. 3,856,180 discloses a gas generator using a pressurized gas in which an igniter and a gas discharge port are separated. In a gas generator using a pressurized gas, a rupturable plate is employed as blockage member for blocking the gas discharge port, but during the actuation, the rupturable plate has to be ruptured to open the gas discharge path. In U.S. Pat. No. 3,856,180, a structure is employed in which a rupturable plate is ruptured by a rod actuated by a high-temperature high-pressure gas generated by the actuation of ignition device.

In the invention of U.S. Pat. No. 3,856,180, a seal 80 is formed integrally with a wall 14, and fragile portions are formed as grooves 82, 84 having a V-shaped cross section. A rod 74 is moved by the actuation of a squib 44 and a gas generating agent 34 and breaks the seal from the portion of the V-shaped grooves 82, 84.

### SUMMARY OF THE INVENTION

The present invention provides a gas generator including:
a cylindrical housing having two opening portions;
an ignition device chamber connected to one of the opening portions of the cylindrical housing;
a diffuser portion connected to the other opening portion of the cylindrical housing and having a gas discharge port;
a first blockage member closing between the cylindrical housing and the ignition device chamber;
a second blockage member closing between the cylindrical housing and the diffuser portion;
a pressurized gas charged inside the cylindrical housing,
a rod, for rupturing the second blockage member to open a path to the diffuser portion in actuation, being provided inside the cylindrical housing, a base portion of the rod being disposed to face the first blockage member, a distal end portion of the rod being disposed to face the second blockage member

the rod including the distal end portion having a flat surface which faces the second blockage member and a central portion which is other than the distal end portion and the base portion, an outer diameter of the distal end portion being larger than that of the central portion.

### BRIEF DESCRIPTION OF DRAWINGS

The present invention will become more fully understood from the detailed description given hereinbelow and the accompanying drawings which are given by way of illustration only, and thus are not limitative of the present invention and wherein:

FIG. 1 shows a longitudinal sectional view of a gas generator;

FIG. 2 shows a partial enlarged view of the gas generator shown in FIG. 1;

FIG. 3 shows a longitudinal sectional view of the gas generator using a rod of another embodiment; and

FIG. 4 shows a longitudinal sectional view of the gas generator using a rod of yet another embodiment.

### DETAILED DESCRIPTION OF THE INVENTION

In the gas generator of U.S. Pat. No. 3,856,180, V-shaped grooves have to be formed to rupture the seal reliably.

Further, in the gas generator of U.S. Pat. No. 3,856,180, V-shaped grooves 82, 84 have to be formed and the production and processing of parts become complicated, thereby increasing the production cost. Furthermore, because the depth or width of the V-shaped grooves 82, 84 have to be strictly controlled to rupture the seal, the control of components becomes cumbersome in terms of quality assurance.

The present invention provides a gas generator in which an igniter and a gas discharge port are provided in separate positions and blockage member of a gas discharge channel leading to the gas discharge port is broken with a rod, wherein the blockage member can be ruptured reliably to discharge the gas and inflate the air bag.

When the gas generator is actuated, the first blockage member is broken by the ignition device, the rod is moved forward, the second blockage member is broken by the rod, and the gas discharge path leading to the gas discharge port is opened, whereby the air bag is inflated. In such operation, the following two requirements are especially important:

Requirement (a): the second blockage member is broken reliably.

Requirement (b): the pressurized gas is discharged instantaneously without the occurrence of resistance impeding the gas flow in the gas channel after the second blockage member is broken.

When a pressurized gas is discharged from the gas generator, a portion producing resistance to the flow appears in the gas channel formed inside the gas generator, and the resistance increases with the decrease in the cross-sectional area of the gas channel. For this reason, using a rod having a larger outer diameter is considered with the object of breaking the second blockage member over a large surface area, but after the second blockage member has been broken, the rod itself narrows the gas channel and generates a large resistance to gas flow. In this case the two requirements (a), (b) cannot be satisfied at the same time.

In accordance with the present invention, as the rod for breaking the second blockage member, such a rod is used that includes a base portion, a central portion, and a distal end portion having a flat surface, wherein the distal end portion is formed so that the outer diameter thereof is larger than the outer diameter of the central portion. Accordingly, because the second blockage member is broken by a shear force created by the impact of the surface of the distal end portion of the rod, the second blockage member assumes the same rupturing state all the time, regardless of the actuation environment of the gas generator. Moreover, because the central portion of the rod has a smaller outer diameter, the gas channel is prevented from being narrowed and the occurrence of resistance impeding the gas flow is suppressed. Furthermore, decreasing the size of the central portion reduces the weight of the entire rod and facilitates the propulsion thereof by the ignition device.

The cross-sectional shape of the central portion and distal end portion of the rod is preferably round, but may be polygonal. The central portion and distal end portion can be formed from separate components and can be joined together at the time of assembling, or the two can be formed integrally.

The distal end portion (enlarged-diameter portion) and the central portion (reduced-diameter portion) may be formed so that the outer diameter thereof is set discontinuously or changed continuously.

The cylindrical housing has a cylindrical outer shape, but no limitation is placed on the positions of two opening portions, and the two opening portions may be provided at both ends, or in the circumferential surface, or at one end and in the circumferential surface.

As the first blockage member and the second blockage member, a rupturable plate, that is formed of a round plate of a stainless steel or the like such as is used in a hybrid inflator and can withstand a pressure inside the cylindrical housing and to maintain an air-tight state, may be used.

The present invention preferably provides the gas generator, wherein the second blockage member blocks a gas channel formed between the cylindrical housing and the diffuser portion, and an outer diameter (B₁) of the distal end surface of the rod and a diameter (A) of the gas channel satisfy the following relationship: ½A≦B₁<A.

The requirement (a) is readily satisfied when the relationship between the outer diameter (B₁) of the distal end surface of the rod and the diameter (A) of the gas channel is within the above-described range.

The second blockage member is broken through along the contour of almost the same shape as the distal end portion of the rod by a shear force, and the center portion thereof falls off in a single piece but the circumferential portion other than the center portion does not falls off. Because the separated central portion is held in a sandwiched state between the distal end portion of the rod and the inner surface of the diffuser portion, if B₁ and A satisfy the relationship represented by the formula above, the separated central portion does not block the gas channel.

The rod is disposed so that the center of the distal end portion of the rod and the center of the second blockage member are located on the same line. The outer diameter (B₁) of the surface of the distal end portion of the rod (the length between the opposing apexes when the surface of the distal end portion has a polygonal shape) is preferably 75% or more and less than 100% of the diameter (A) of the cross-section of the gas channel.

The distal end portion of the rod can be tapered so that when the rod moves, even if the distal end portion comes into contact with the gas channel, it does not affect adversely the rod movement.

The present invention preferably provides the gas generator, wherein an outer diameter (B₂) of the central portion of the rod and the diameter (A) of the gas channel satisfy the following relationship: B₂≦½A.

The requirement (b) is readily satisfied when the relationship between the outer diameter (B₂) of the central portion of the rod and the diameter (A) of the gas channel is within the above-described range.

The present invention preferably provides the gas generator, wherein the diffuser portion has a cup-like shape having a plurality of gas discharge ports in a circumferential wall portion thereof, and after the second blockage member has been broken by the rod, the surface of the distal end portion comes into contact with a bottom surface of the diffuser portion not to block the gas discharge ports.

When the distal end portion of the rod pierces the central portion of the second blockage member and reaches the diffuser portion, the pushed-through central portion is sandwiched and held between the surface of the distal end portion of the rod and the closed end surface (bottom surface of the diffuser portion). Furthermore, because the distal end portion of the rod is flat, when the distal end portion of the rod collides with the bottom surface of the diffuser portion, the force is dissipated and, therefore, the rod does not penetrate therethrough. Accordingly, it is not necessary to increase the thickness of the bottom surface of the diffuser portion and the processing of parts is facilitated.

When a gas discharge port formed in the vicinity of the closed end surface, of a plurality of gas discharge ports formed in the circumferential wall portion of the diffuser portion, is formed at a distance from the closed bottom surface equal to or larger than the thickness of the distal end portion of the rod, all the gas discharge ports of the circumferential wall portion of the diffuser can be opened even when the surface of the distal end portion of the rod is brought into contact with the bottom surface of the diffuser portion.

The present invention preferably provides the gas generator, wherein the central portion of the rod has a groove serving as a gas channel.

By thus forming a groove serving as a gas channel in the central portion of the rod, the gas flow is prevented from being impeded and the above-described requirement (b) is readily satisfied.

The groove may be a continuous groove from the base portion of the rod to the distal portion of the rod or a discontinuous groove, provided that it does not impede the gas flow. One or a plurality of grooves may be provided, and the groove may have a spiral or linear shape.

When a groove is thus formed, a shape is assumed in which a plurality of projections and recesses (or peaks and valleys) are formed in the circumferential direction, in a cross-sectional view in the radial direction. Of those projections and recesses, the recesses serve as gas channels, and the projections act as ribs reinforcing the rod. Therefore, even when the length of the rod is increased, it is prevented from deformation such as bending.

The groove many be formed over the entire area of the central portion of the rod or only in part thereof. When it is formed in part, it can be formed in a portion positioned in a path leading to the diffuser portion after the rod has been moved.

The present invention preferably provides the gas generator, wherein the surface area of the surface of the base portion of the rod that faces the first blockage member is larger than the cross-sectional area of the central portion of the rod.

Because the base portion of the rod is a portion that receives combustion products such as a shock wave and a pressure wave generated from the ignition device (electric igniter), the surface of the base portion of the rod is preferably formed to have a diameter larger than that of the central portion.

With the gas generator in accordance with the present invention, the second blockage member is broken reliably and over a large surface area, the gas channel is opened, and after the second blockage member has been broken, a pressurized gas is released instantaneously, inflating the air bag.

### Embodiment of Invention

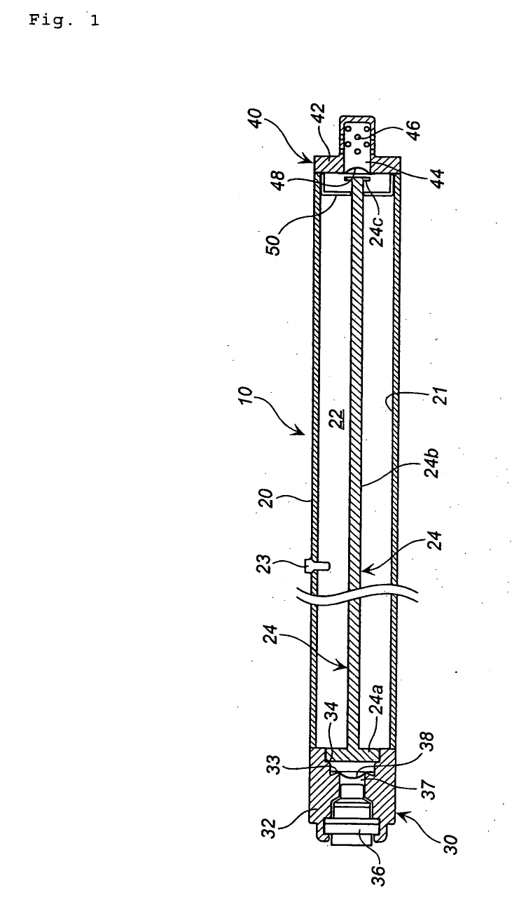

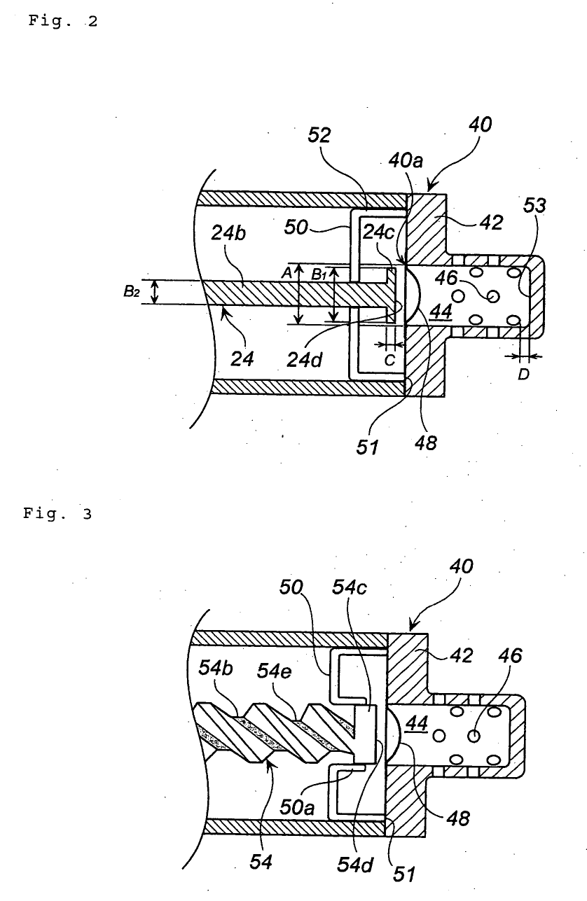

(1) Gas Generator Shown in FIG. 1, FIG. 2

The gas generator shown in FIG. 1 is a stored gas type using a pressurized gas in order to inflate an air bag. FIG. 1 is a sectional view in the axial direction, and FIG. 2 is a partial enlarged view of the configuration shown in FIG. 1.

A cylindrical housing 20 has two opening portions at both ends thereof, an ignition device chamber 30 connected to the opening portion at one end, and a diffuser portion 40 connected to the opening portion at the other end. Those components are made from stainless steel or aluminum and fixed by welding in the respective joints thereof.

The inside of the inner space 22 of the cylindrical housing 20 is maintained in an air-tight state and charged with a single gas such as argon, helium, nitrogen, or a gas mixture thereof (the charging pressure is about 35,000 to 70,000 kPa). The pressurized gas preferably has a sound velocity of 400 m/sec or more at a temperature of 0° C. and under a pressure of 1 atm (101.325 kPa). The pressurized gas is charged from a charging hole and then blocked with a pin 23. The pin 23 is welded to the cylindrical housing 20.

The ignition device chamber 30 has an outer shell formed by an ignition device chamber housing 32. An electric igniter 36 provided with an ignition agent is accommodated inside the ignition device chamber housing 32. The igniter 36 is connected to a power supply circuit of the vehicle via a connector and a lead wire (none is shown in the drawings). For the igniter 36, 260 mg of an ignition agent including zirconium and potassium perchlorate as the main components is used.

A first passage 37 located between the cylindrical housing 20 (inner space 22) and ignition device chamber 30 is blocked by a first rupturable plate 38 made from stainless steel, and the inside of the ignition device chamber 30 is under a normal pressure. The circumferential edge portion of the first rupturable plate 38 is fixed by welding to a first annular step surface 33 provided at the inner surface of the ignition device chamber housing 32.

In the diffuser portion 40, an outer shell is formed by a diffuser housing 42, and a plurality of gas discharge holes 46 for discharging the pressurized gas to the outside are uniformly arranged in the diffuser housing 42.

A second passage 44 located between the cylindrical housing 20 (inner space 22) and diffuser portion 40 is blocked by a second rupturable plate 48 made from stainless steel, and the inside of the diffuser portion 40 is under a normal pressure. The circumferential edge portion of the second rupturable plate 48 is welded and fixed to the diffuser housing 42.

A rod 24 for rupturing and opening the second rupturable plate 48 is disposed inside the cylindrical housing 20. The rod 24 has a base portion 24a in the form of a round disk, a central portion (shaft portion) 24b, and a distal end portion 24c; all the portions are formed integrally from a metal such as stainless steel or aluminum. In the distal end portion 24c of the rod, the side facing the second rupturable plate 48 is in the form of a round disk.

The base portion 24a of the rod comes into contact with the second annular step surface 34 provided at the inner surface of the ignition device housing 32. In the configuration shown in FIG. 1, the first rupturable plate 38 and base portion 24a are separate members, but the base portion 24a and first rupturable plate 38 may be formed integrally. Furthermore, the base portion 24a may also serve as the first rupturable plate 38.

The retainer 50 is fitted (or press-inserted) in a state where it comes into contact with the inner wall surface 21 of the cylindrical housing 20 and the diffuser housing 42 and holds a portion close to the distal end portion 24c in the central portion 24b of the rod 24.

As a result, because the rod 24 is fixed in the predetermined position by the retainer 50 and the ignition device chamber housing 32, the rod 24 is prevented from shaking under the effect of vibrations, etc., induced from the outside.

The distal end portion 24c of the rod 24 is disposed opposite the second rupturable plate 48 that blocks between the cylindrical housing 20 and the second passage 44 at a certain distance therefrom. The second passage 44 serves as a gas channel, the inner diameter (A) thereof is larger than the outer diameter (B₁) of the distal end portion surface of the distal end portion 24c of the rod. In the configuration shown in FIG. 2, B₁ is set to 90% of A.

The retainer 50 is fitted into the cylindrical housing 20 and fixes the rod 24 so that the center of the distal end portion surface 24d of the distal end portion 24c of the rod is on the same line as the center of the second passage 44.

The circumferential edge portion 51 of the retainer 50 abuts against the diffuser housing 42, and the circumferential surface portion 52 abuts against the inner wall surface 21 of the cylindrical housing 20.

The operation of the gas generator 10 shown in FIG. 1 and FIG. 2 in the case where it was assembled with an air bag system of an automobile will be described below. In the gas generator 10, the igniter 36 from which a lead wire is led out and the gas discharge port 46 where the air bag is attached are located on the opposite sides. Therefore, the lead wire does not become an obstacle during the air bag attachment operation.

When an automobile collides and receives an impact, an actuation signal is received from a control unit, the igniter 36 is actuated and ignited, the first rupturable plate 38 is broken by the generated shock wave and pressure wave, and the first passage 37 is opened. The shock wave or pressure wave that has broken the first passage 37 then hits the disk portion (base portion) 24a of the rod and pushes the rod 24 toward the second rupturable plate 48.

As a result, the rod 24 moves in the axial direction, the distal end portion 24c of the rod collides with the second rupturable plate 48, the second rupturable plate 48 is broken through along the contour of almost the same shape as the surface 24d of the distal end portion and falls off under the effect of a shear force and assumes a state in which it is sandwiched between the surface 24d of the distal end portion and the bottom surface 53 of the diffuser portion 40. At this time, if the thickness C of the distal end portion 24c and the distance D to a discharge port among the gas discharge ports 46 formed in the diffuser portion 40 that is the closest to the bottom surface 53 of the diffuser satisfy the relationship D>C, then the gas discharge ports 46 are not closed even after the rod 24 has moved.

If necessary, a fixing member may be provided to prevent the rod 24 from moving (maintain a state in which the distal end portion 24c and the bottom surface 53 of the diffuser are in contact) after actuation.

A taper may be formed at the distal end portion 24c of the rod in order to prevent the distal end portion 24c of the rod from interfering with a corner portion 40a of the diffuser 40 forming the second passage 44 when the rod 24 is moved.

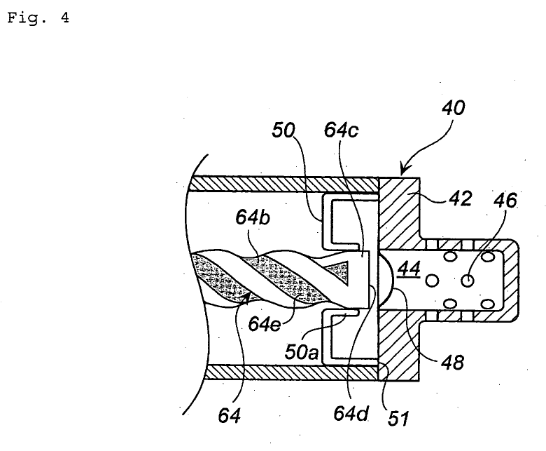

(2) Gas Generator Shown in FIG. 3

FIG. 3 shows a gas generator of an embodiment different from that shown in FIG. 1. FIG. 3 is a partial sectional view in the axial direction. The gas generators shown in FIG. 3 and FIG. 1 differ only in the rods and retainers.

Similarly to the rod 24 shown in FIG. 1, a rod 54 shown in FIG. 3 has a base portion (not shown in the drawing), a central portion 54b, a distal end portion 54c, and a surface 54d of the distal end portion, but has a spiral groove (wood screw) 54e for forming a gas channel in he central portion 54b. The concavity (or valley) of the groove 54e serves as a gas channel, and the convexity (or peak) serves as a reinforcing portion.

The surface 54d of the distal end portion of the rod has a round shape and the outer diameter thereof is 90% of the inner diameter of the second passage 44. The diameter between convexity peaks of the central portion 54b is equal to or less than the diameter of the surface 54d of the distal end portion of the rod.

The retainer 50 has a flange 50a folded so that the outer peripheral surface of the distal end portion 54c of the rod can be held in a wider range.

(3) Gas Generator Shown in FIG. 4

FIG. 4 shows a gas generator of an embodiment different from that shown in FIG. 1. FIG. 4 is a partial sectional view in the axial direction. The gas generators shown in FIG. 4 and FIG. 1 differ only in the rods and retainers.

Similarly to the rod 24 shown in FIG. 1, a rod 64 shown in FIG. 4 has a base portion (not shown in the drawing), a central portion 64b, a distal end portion 64c, and a surface 64d of the distal end portion, but has a spiral-groove (drill-shaped groove) 64e for forming a gas channel in the central portion 64b. The concavity of the groove 64e serves as a gas channel, and the convexity serves as a reinforcing portion.

The surface 64d of the distal end portion of the rod has a round shape and the outer diameter thereof is 90% of the inner diameter of the second passage 44. The diameter between the convexity peaks of the central portion 64b is equal to or less than the diameter of the surface 64d of the distal end portion of the rod.

The retainer 50 has a flange 50a folded so that the outer peripheral surface of the distal end portion 64c of the rod can be held in a wider range.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator comprising:
a cylindrical housing having two opening portions;
an ignition device chamber connected to one of the opening portions of the cylindrical housing;
a diffuser portion connected to the other opening portion of the cylindrical housing and having a gas discharge port;
a first blockage member closing between the cylindrical housing and the ignition device chamber;
a second blockage member closing between the cylindrical housing and the diffuser portion;
a pressurized gas charged inside the cylindrical housing,
a rod, for rupturing the second blockage member to open a path to the diffuser portion in actuation, being provided inside the cylindrical housing, a base portion of the rod being disposed to face the first blockage member, a distal end portion of the rod being disposed to face the second blockage member,
the rod including the distal end portion having a flat surface which faces the second blockage member and a central portion which is other than the distal end portion and the base portion, an outer diameter of the distal end portion being larger than that of the central portion.

2. The gas generator according to claim 1, wherein the second blockage member blocks a gas channel formed between the cylindrical housing and the diffuser portion, and an outer diameter (B₁) of the distal end surface of the rod and a diameter (A) of the gas channel satisfy the following relationship: ½A≦B₁<A.

3. The gas generator according to claim 2, wherein an outer diameter (B₂) of the central portion of the rod and the diameter (A) of the gas channel satisfy the following relationship: B₂≦½A.

4. The gas generator according to claim 1, wherein the diffuser portion has a cup-like shape having a plurality of gas discharge ports in a circumferential wall portion thereof, and after the second blockage member has been broken by the rod, the surface of the distal end portion comes into contact with a bottom surface of the diffuser portion not to block the gas discharge ports.

5. The gas generator according to claim 1, wherein the central portion of the rod has a groove serving as a gas channel.

6. The gas generator according to claim 1, wherein the surface area of the surface of the base portion of the rod that faces the first blockage member is larger than the cross-sectional area of the central portion of the rod.
